(19) United States
(12) Patent Application Publication
(10) Pub. No.: US 2023/0088497 A1
(43) Pub. Date: Mar. 23, 2023

(54) INFORMATION PROCESSING SERVER DEVICE AND TERMINAL DEVICE FOR ELECTRONIC RECEIPT SYSTEM OFFERING DELIVERY SERVICES

(71) Applicant: TOSHIBA TEC KABUSHIKI KAISHA, Tokyo (JP)

(72) Inventors: Yumiko OKUMA, Koganei Tokyo (JP); Keiichi HASEGAWA, Koto Tokyo (JP); Yujiro UGAERI, Suginami Tokyo (JP); Nobuaki YAMAUCHI, Yokohama Kanagawa (JP); Yusuke OHTANI, Edogawa Tokyo (JP)

(21) Appl. No.: 17/835,351

(22) Filed: Jun. 8, 2022

(30) Foreign Application Priority Data
Sep. 17, 2021 (JP) 2021-152071

(51) Int. Cl. G06Q 20/04; G06Q 30/06; G06Q 30/02

(52) U.S. Cl. CPC G06Q 20/047; G06Q 30/0633; G06Q 30/0222

(57) ABSTRACT

According to one embodiment, an information processing server device for an electronic receipt system includes a communication interface configured to receive electronic receipt data from a plurality of stores, a storage unit for storing electronic receipt data received from the plurality of stores in association with a user ID, and a processor. The processor acquires information from the stored electronic receipt data about items of merchandise purchased within a predetermined period by a user associated with the user ID, and causes a user terminal associated with the user ID to display the information about the items of merchandise purchased during the predetermined period along with a delivery request button. The processor can receive, via the communication interface, a delivery request from the user terminal for one or more items of merchandise, and then transmit, via the communication interface, information relating to the delivery request to a delivery person terminal.

### CROSS-REFERENCE TO RELATED APPLICATION

This application is based upon and claims the benefit of priority from Japanese Patent Application No. 2021-152071, filed Sep. 17, 2021, the entire contents of which are incorporated herein by reference.

### FIELD

Embodiments described herein relate generally to an information processing server device and a terminal device for an electronic receipt service which can offer delivery service to a customer.

### BACKGROUND

In some cases, if a shopper visits a plurality of stores to purchase items of merchandise, the total number of purchased items the shopper must carry store to store increases with each stop. Eventually, the weight (or volume) of the purchased items may become difficult to carry or take home. In the related art, there are various delivery services, but the existing delivery services are generally unsuitable for handling multi-store shopping trips or the like.

In the related art, there is a service type by which a store may accept the delivery of items purchased at another related store (e.g., same store chain or same overall corporate ownership). However, in general, the reception timing for such delivery service is limited to just after the shopper has purchased items at the store, and items other than those purchased at the store or related store are not accepted for delivery to the shopper's home.

In some instances, in the related art, a convenience store or the like functions as a collection point for a delivery company. However, such a collection point basically receives only an already wrapped package, and thus is not suitable for the above case of receiving multiple items from separate stores that have been purchased by the shopper on the same shopping trip or the like. Also, it is necessary for the shopper (or someone) to fill out packing/mailing slips, weigh the package for delivery cost calculation, and thus the procedure to use such a collection point for multiple items from multiple locations is complicated.

There is a system that collects and stores information about items purchased by a user as electronic receipt data (for example, JP-A-2019-091502). Various methods for utilizing electronic receipt data have been suggested so far, and have the potential to provide improved convenience for shoppers in various scenarios.

### BRIEF DESCRIPTION OF THE DRAWINGS

FIG. 1 is a schematic view of an electronic receipt system and a flow of information in the system according to an embodiment.

FIG. 2 is a block diagram illustrating an example of a hardware configuration of a delivery person terminal.

FIG. 3 is a block diagram illustrating an example of a hardware configuration of a user terminal.

FIG. 4 is a block diagram illustrating an example of a hardware configuration of a server.

FIG. 5 is a diagram illustrating an example of a data configuration of merchandise information.

FIG. 6 is a diagram illustrating an example of a data configuration of user information.

FIG. 7 is a diagram illustrating an example of a data configuration of coupon information.

FIG. 8 is a diagram illustrating an example of a data configuration of electronic receipt data.

FIG. 9 is a diagram illustrating functional aspects of a control unit of a server.

FIG. 10 is a flowchart of a recommendation process performed by a server.

FIG. 11 is a diagram illustrating functional aspects of a control unit of a user terminal.

FIG. 12 is a sequence chart illustrating an example of a flow of operations of a user terminal and a server from electronic receipt app start to electronic receipt display.

FIG. 13 is a diagram illustrating an example of an electronic receipt screen.

FIG. 14 is a diagram illustrating an example of a displaying method of an electronic receipt screen.

FIG. 15 is a diagram illustrating an example of a delivery reservation screen.

FIG. 16 is a diagram illustrating an example of a displaying method of a delivery reservation screen in an initial state.

FIG. 17 is a sequence chart illustrating an example of a flow of operations of a user terminal and a server from delivery condition change to update of a delivery amount estimated value.

FIG. 18 is a diagram illustrating an example of the delivery reservation screen after a condition change operation.

FIG. 19 is a diagram illustrating an example of a pick-up place selection screen.

FIG. 20 is a diagram illustrating an example of a pick-up time selection screen.

FIG. 21 is a sequence chart illustrating an example of a flow of operations of a user terminal and a server from editing of delivery request information to a collection information display.

FIG. 22 is a diagram illustrating an example of a delivery reservation completion screen.

### DETAILED DESCRIPTION

An object to be achieved by the present disclosure is to provide an information processing device making the performance of a merchandise delivery request for items obtained during a shopping trip to be performed. The items may be obtained at multiple stores in the course of the shopping trip, and the accumulation of items during the shopping trip may be tracked by using electronic receipt data.

In general, according to one embodiment, an information processing server device for an electronic receipt system includes a communication interface configured to receive electronic receipt data from a plurality of stores, a storage unit for storing electronic receipt data received from the plurality of stores in association with a user ID, and a processor. The processor is configured to acquire information from the stored electronic receipt data about items of merchandise purchased within a predetermined period by a user associated with the user ID. The processor then causes a user terminal associated with the user ID to display the information about the items of merchandise purchased during the predetermined period along with a delivery request button. The processor is configured to receive, via the communication interface, a delivery request from the user terminal for one or more items of merchandise, and then transmit, via the communication interface, information relating to the delivery request to a delivery person terminal.

### First Embodiment

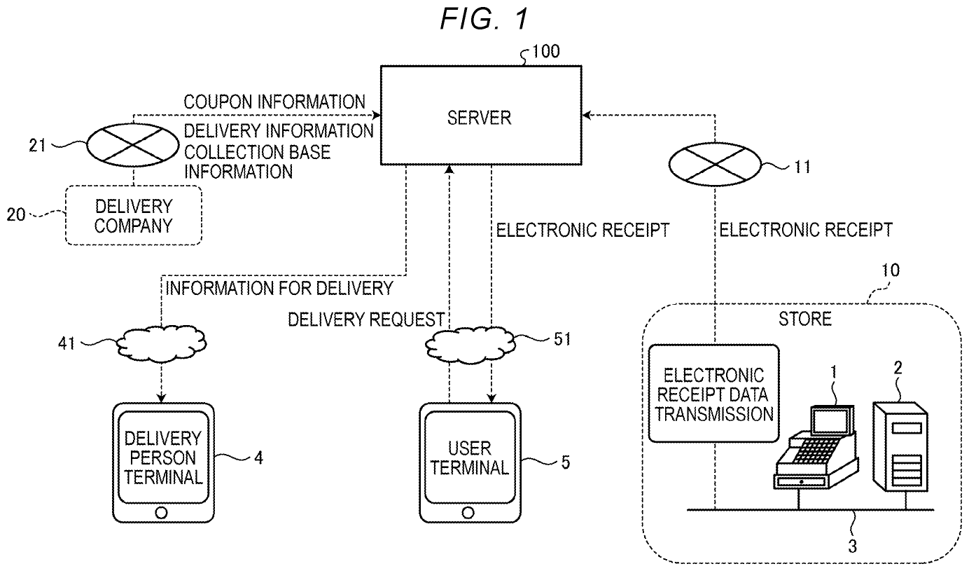

FIG. 1 is a schematic view illustrating a configuration of an electronic receipt system and a flow of information between configurations according to a first embodiment. As illustrated in FIG. 1, the electronic receipt system includes a Point of Sales (POS) terminal 1, a store server 2, an in-store network 3 such as a local area network (LAN), a delivery person terminal 4, a user terminal 5, a server 100, and the like.

The POS terminal 1 and the store server 2 are provided in a store 10. The POS terminal 1 and the store server 2 are communicably connected via the in-store network 3. The POS terminal 1 and the store server 2 can be connected to a network 11 that connects the store 10 and the server 100 via a network apparatus such as a router connected to the in-store network 3. Here, the network 11 is, for example, a dedicated line such as a virtual private network (VPN).

The POS terminal 1 is a merchandise sales data processing device that performs a merchandise sales data process. The POS terminal 1 generates receipt data reflecting sales transaction content and can output a paper receipt by printing out the corresponding receipt data with a printer. In addition, the POS terminal 1 outputs (transmits) electronic receipt data to the server 100 via the network 11. The electronic receipt data may be obtained by conversion of the receipt data for printing or otherwise. The transmission method of the electronic receipt data is not particularly limited, and a general-purpose protocol such as HTTP or HTTPS may be used. The number of the POS terminals 1 provided in the store 10 is not particularly limited, and a plurality of such terminals may be used.

The store server 2 comprehensively manages the merchandise sales data process or the like performed by the POS terminal 1. For example, the store server 2 stores and manages merchandise sales data generated by the merchandise sales data process of the POS terminal 1 and stores and manages a merchandise data file or the like used for the merchandise sales data process.

The number of the POS terminals 1 disposed in the store 10 is not particularly limited, and a plurality of terminals may be used. According to the present embodiment, the POS terminal 1 outputs the electronic receipt data, but the embodiment is not limited thereto. The electronic receipt data can be obtained by converting a data format for the receipt data generated by the POS terminal 1, the store server 2, or a conversion device then such converted information can be output to the server 100.

The server 100 is an example of an information processing device and is a device that manages various kinds of information such as electronic receipt data. In the example illustrated in FIG. 1, the server 100 is a single device, but the server 100 may be configured by combining a plurality of devices.

The server 100 is communicably connected via a network 21 to an information processing terminal, such as a personal computer (PC), of a delivery company 20. The network 21 may be a dedicated line such as a VPN. The server 100 appropriately stores the information such as coupon information, delivery person information, collection base information, and the like received from the delivery company 20. The server 100 also stores electronic receipt data that is received from the store 10. Here, the delivery person information is a name or ID information of a person registered as a delivery person or information (a telephone number, an e-mail address, or the like) for specifying a terminal device (the delivery person terminal 4) used by the corresponding person. In addition, the server 100 transmits the stored information to an external device (e.g., the user terminal 5 or the delivery person terminal 4) in response to a request.

The delivery person terminal 4 is a terminal device that is used by a person (delivery person) who handles or manages the delivery of a package. For example, a portable terminal such as a smart phone is used. In some examples, the delivery person terminal 4 may be a stationary information processing terminal such as a PC disposed at a collection point such as a reception counter provided in a store. The delivery person terminal 4 is communicably connected to the server 100 by a network 41, which may be a public line network.

In the same manner, the user terminal 5 is a terminal device that is used by a user (client) of the present system. For example, a portable terminal such as a smart phone is used. The user terminal 5 is communicably connected to the server 100 by a network 51, which may be a public line network.

In addition, an application for browsing various kinds of information provided from the server 100 is installed in the delivery person terminal 4 and the user terminal 5.

The user terminal 5 recognizes a member of the present system by an access to the server 100 via the network 51. Member registration of a client is performed, for example, by the following procedure. The client transmits a blank message (e-mail) from the user terminal 5 to the server 100 via the network 51. The server 100 transmits a uniform resource locator (URL) to the received e-mail address indicating a page for registering a member. The client accesses the URL for member registration from the user terminal 5 to cause an input screen to be displayed, and inputs items (a name, transmission destination information, and the like) required for member registration. After inputting of required items is completed, the server 100 registers the member in a member master table or file. Thereafter, the server 100 delivers a member registration completion e-mail including a member code (an example of client specification information) and a password to the user terminal 5. Accordingly, the member registration is completed.

After the member registration, the user terminal 5 displays a member code of the client as a code symbol CS such as a barcode or a two-dimensional code. The client presents the code symbol CS displayed on the user terminal 5 to a clerk at the time of transaction settlement in the store 10. The clerk reads the code symbol CS displayed on the user terminal 5, for example, using a scanner connected to the POS terminal 1. Accordingly, the member code of the client can be associated with receipt data generated after the settlement by the merchandise sales data process at the POS terminal 1.

After the transaction settlement at the POS terminal 1, the user terminal 5 receives the electronic receipt data from the server 100 via the network 51 and displays the electronic receipt data for the transaction. With respect to the reception, specifically, the user terminal 5 receives the electronic receipt data from the server 100 by transmitting an electronic receipt inquiry (request) designating the member code to the server 100 via the network 51.

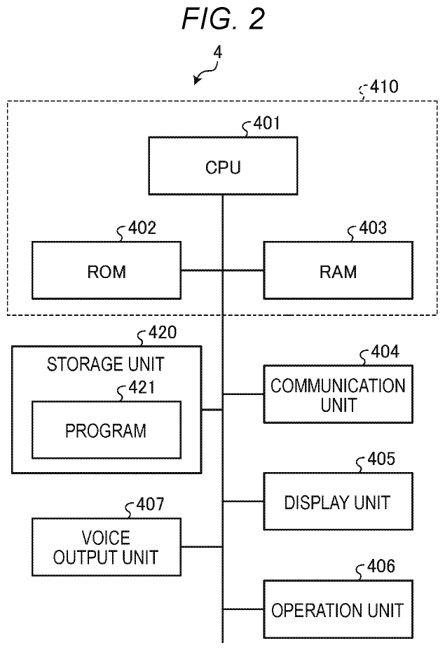

FIG. 2 is a block diagram illustrating an example of the hardware configuration of the delivery person terminal 4. As illustrated in FIG. 2, the delivery person terminal 4 includes a central processing unit (CPU) 401, a read only memory (ROM) 402, a random access memory (RAM) 403, a communication unit 404, a display unit 405, an operation unit 406, a voice output unit 407, and a storage unit 420. In addition, the delivery person terminal 4 includes a camera that captures and outputs an image.

The CPU 401 is an example of a processor and comprehensively controls operations of the delivery person terminal 4. The ROM 402 stores various programs. The RAM 403 is a work space onto which a program or various kinds of data is loaded.

The CPU 401, the ROM 402, and the RAM 403 are connected to each other via a bus and configure a control unit 410. In the control unit 410, various processes are performed by operation of the CPU 401 according to a program that is stored in the ROM 402 or the storage unit 420 and loaded onto the RAM 403. The control unit 410 is connected to the storage unit 420, the communication unit 404, the display unit 405, the operation unit 406, and the voice output unit 407 via a bus.

The storage unit 420 is configured, for example, with a solid-state drive (SSD) or a flash memory, and thus maintains stored contents even if the power is cut off. The storage unit 420 stores various programs executed by the CPU 401 and various kinds of setting information relating to the operation of the delivery person terminal 4. For example, the storage unit 420 stores a program 421 such as an application program (delivery person app) relating to the display of the information such as information for delivery that is provided from the server 100. In addition, the storage unit 420 includes an application program (a code reader or the like) for reading information from the image captured by the camera included in the delivery person terminal 4 and performing a predetermined process.

The communication unit 404 is a wired or wireless communication interface that can be connected to the network 41. The communication unit 404 communicates with an external device such as the server 100 via the network 41.

The display unit 405 is a display device such as a liquid crystal display (LCD) and displays various kinds of information according to the control of the control unit 410. The display unit 405 is implemented, for example, by a touch panel display.

The operation unit 406 includes various operation buttons and outputs key information to the control unit 410 in response to the operation of an operator. In addition, the operation unit 406 includes a touch panel provided on the display surface of the display unit 405.

The voice output unit 407 is a voice output device such as a speaker and outputs a voice according to the control of the control unit 410.

The hardware configuration of the delivery person terminal 4 is not limited to the example of FIG. 2. For example, if the delivery person terminal 4 is a smart phone, the delivery person terminal 4 may include a communication module for 4G, 5G, or the like and a voice input unit such as a microphone.

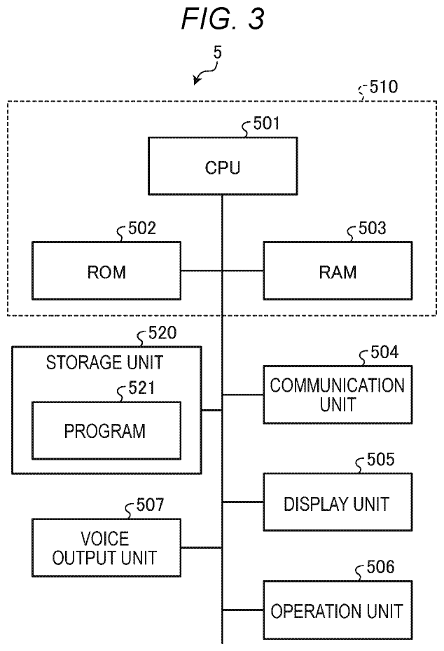

FIG. 3 is a diagram illustrating an example of a hardware configuration of the user terminal 5. As illustrated in FIG. 3, the user terminal 5 includes a CPU 501, a ROM 502, a RAM 503, a communication unit 504, a display unit 505, an operation unit 506, a voice output unit 507, and a storage unit 520.

The CPU 501 is an example of the processor and comprehensively controls an operation of the user terminal 5. The ROM 502 stores various programs. The RAM 503 is a work space for loading a program or various kinds of data.

The CPU 501, the ROM 502, and the RAM 503 are connected to each other via a bus and configure a control unit 510. In the control unit 510, various processes are performed by the operation of the CPU 501 according to the program that is stored in the ROM 502 or the storage unit 520 and loaded onto the RAM 503. The control unit 510 is connected to each unit (the storage unit 520, the communication unit 504, the display unit 505, the operation unit 506, or the voice output unit 507) via a bus.

The storage unit 520 is configured, for example, with an SSD or a flash memory and maintains stored contents even if the power is cut off. The storage unit 520 stores various programs executed by the CPU 501 or various kinds of setting information relating to the operation of the user terminal 5. For example, the storage unit 520 stores a program 521 such as application programs (electronic receipt app and user app) relating to the display of the information such as the electronic receipt data that is provided from the server 100.

The communication unit 504 is a wired or wireless communication interface that can be connected to the network 51. The communication unit 504 communicates with the external device such as the server 100 via the network 51.

The display unit 505 is a display device such as LCD and displays various kinds of information according to the control of the control unit 510. The display unit 505 is implemented, for example, by a touch panel display.

The operation unit 506 includes various operation buttons and outputs key information to the control unit 510 in response to the operation of the operator. In addition, the operation unit 506 includes a touch panel provided on the display surface of the display unit 505.

The voice output unit 507 is a voice output device such as a speaker and outputs a voice according to the control of the control unit 510.

The hardware configuration of the user terminal 5 is not limited to the example of FIG. 3. For example, if the user terminal 5 is a smart phone, the user terminal 5 may include a communication module of 4G, 5G, or the like and a voice input unit such as a microphone.

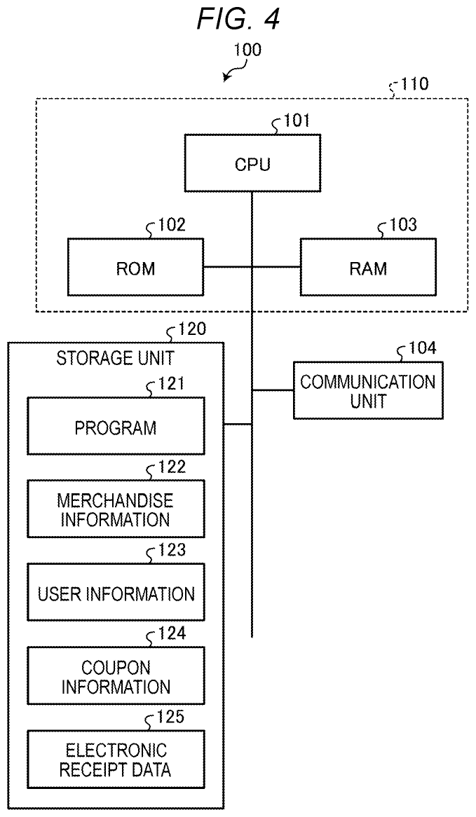

FIG. 4 is a block diagram illustrating an example of the hardware configuration of the server 100. As illustrated in FIG. 4, the server 100 includes a CPU 101, a ROM 102, a RAM 103, a communication unit 104, and a storage unit 120.

The CPU 101 is an example of the processor and comprehensively controls the operation of the server 100. The ROM 102 stores various programs. The RAM 103 is a work space onto which a program or various kinds of data are loaded.

The CPU 101, the ROM 102, and the RAM 103 are connected to each other via a bus and configure a control unit 110. In the control unit 110, various processes are performed by the operation of the CPU 101 according to the program that is stored in the ROM 102 or the storage unit 120 and loaded onto the RAM 103. The control unit 110 is connected to each unit (the storage unit 120 or the communication unit 104) via a bus.

The communication unit 104 is a wired or wireless communication interface that can be connected to the networks 11, 21, 41, and 51. The communication unit 104 communicates with various external devices (the network apparatus of the store 10, information processing devices included in the delivery company 20, the delivery person terminal 4, the user terminal 5, and the like) via the networks 11, 21, 41, and 51.

The storage unit 120 is, for example, a hard disk drive (HDD) or a flash memory and maintains the stored content even if the power is cut off. The storage unit 120 stores various programs executed by the CPU 101 or various kinds of setting information relating to the operation of the server 100. In addition, the storage unit 120 stores a program 121, merchandise information 122, user information 123, coupon information 124, electronic receipt data 125, and the like.

The merchandise information 122, the user information 123, the coupon information 124, and the electronic receipt data 125 are collected, for example, in table formats, respectively and occupy different storage areas of the storage unit 120 that are respectively allocated. In the present embodiment, the merchandise information 122, the user information 123, the coupon information 124, and the electronic receipt data 125 are stored in the same storage unit 120, but may be practically stored in storage units of different devices.

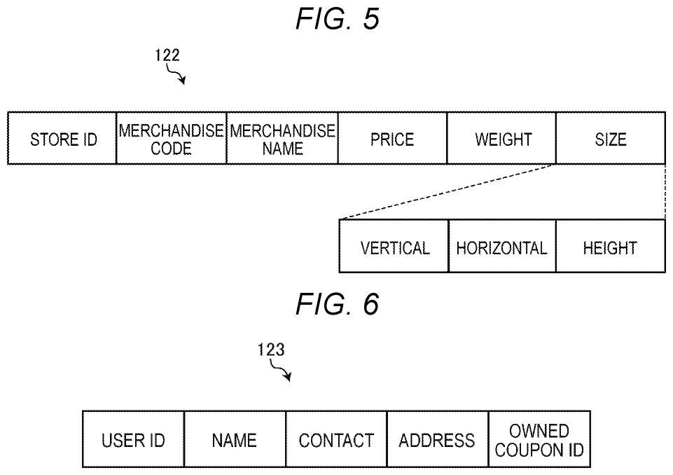

FIG. 5 is a diagram illustrating an example of the data configuration of the merchandise information 122. The merchandise information 122 includes store IDs, merchandise codes, merchandise names, prices, weights, sizes, and the like. The store ID is a unique number or the like with which the store using the electronic receipt system can be specified in the system. The merchandise code is a code with which the merchandise can be specified in the store indicated by the store ID. The merchandise name is the name of a merchandise. The price is a unit price of the merchandise. The weight is the weight of the merchandise. The size is information indicating the size of the merchandise and, for example, includes information such as a vertical dimension, a horizontal dimension, and a height.

FIG. 6 is a diagram illustrating an example of the data configuration of the user information 123. The user information 123 includes user IDs, names, contacts, addresses, owned coupon IDs, and the like. The user ID is a unique number or the like with which the user (client) using the electronic receipt system can be specified in the system. The name is the name of a user. The contact is information that enables contact to the user terminal 5 used by the user and is a telephone number or an e-mail address of the user. The address is information indicating the living place of the user.

The owned coupon ID is information with which a coupon owned by the user can be specified and is the same as the coupon ID of the coupon information 124 described below. The server 100 applies a price discount determined by the coupon to the delivery fee with respect to the delivery request to which the owned coupon ID is added.

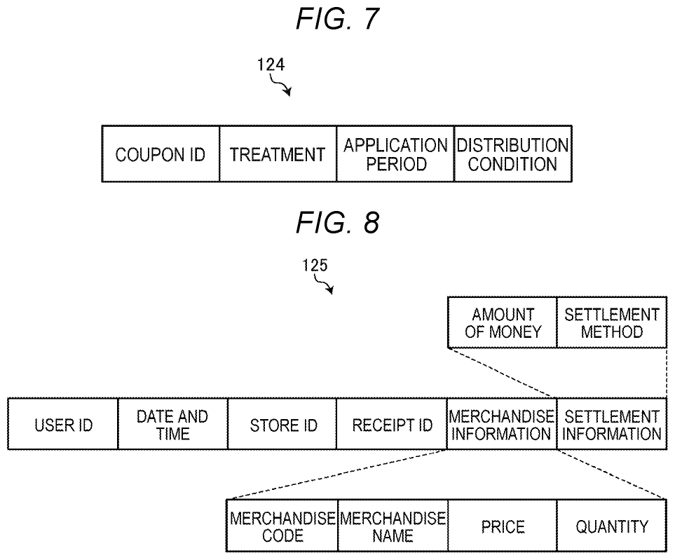

FIG. 7 is a diagram illustrating an example of the data configuration of the coupon information 124. The coupon information 124 includes a coupon ID, a treatment, an application period, distribution conditions, and the like. The coupon ID is unique information which is configured with a number and a symbol and with which a coupon that can be used in the electronic receipt system can be specified. The treatment is a content of a service applied to the user who presents the coupon and is, for example, information relating to the price discount (a discount rate or a discount amount).

The application period is a period during which the service is applied, and is indicated by, for example, a deadline setting of three days from the distribution date or a setting of a period between two different dates. The distribution condition is a condition for distributing the coupon, for example, in which the purchase amount on the day is a price or more.

The coupon information 124 is information which the delivery company 20 appropriately transmits to the server 100.

FIG. 8 is a diagram illustrating an example of the data configuration of the electronic receipt data 125. The electronic receipt data 125 includes a user ID, a date and time, a store ID, a receipt ID, merchandise information, settlement information, and the like.

The user ID is stored in the user information 123 and is a unique number or the like with which the user (client) of the electronic receipt system can be identified by in the system.

The store ID is stored in the merchandise information 122 and is a unique number or the like with which the store can be identified in the system.

The date and time are values indicating the date and time when the transaction was performed. The receipt ID is a unique number or the like by which a particular receipt with the content of the transaction be specified.

The merchandise information is information about items purchased in the transaction as indicated by the record of the electronic receipt data 125 and includes merchandise codes, merchandise names, prices, the number of units, and the like. The merchandise code, the merchandise name, and the price are the same as in the merchandise information stored in the merchandise information 122. The number of units is the number of items with the same corresponding merchandise code purchased in the transaction of the corresponding record.

The settlement information is indicated by the record of the electronic receipt data 125 and includes the price paid and the settlement method. The price paid is the total amount that was due for the items purchased in the corresponding transaction. The settlement method is, the manner of payment provided by the customer, for example, cash, a credit card, electronic money, a gift certificate, or the like.

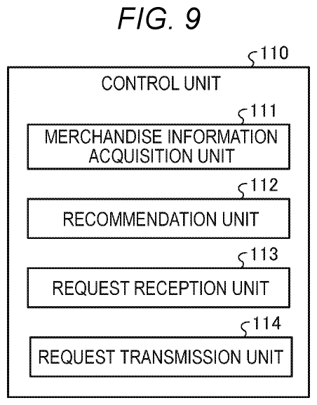

FIG. 9 is a diagram illustrating an example of a functional aspects of the control unit 110 of the server 100. The control unit 110 functions as a merchandise information acquisition unit 111, a recommendation unit 112, a request reception unit 113, and a request transfer unit 114 by the execution of the program 121 by the CPU 101.

The merchandise information acquisition unit 111 extracts (acquires) a record including the information about the merchandise purchased during a predetermined period of time from the electronic receipt data 125 in which the information about the items purchased by the user is recorded. The predetermined period is, for example, the day of the acquisition or within several hours until the time of acquisition. The merchandise information acquisition unit 111 acquires the record in which dates and time are present within the predetermined period in the electronic receipt data 125.

The request reception unit 113, for example, sends the acquired information about the merchandise purchased during the predetermined period to the user terminal 5 and then receives a delivery request (if made by the user via the user terminal 5) for some or all of the items of merchandise purchased during the predetermined period. For example, the user terminal 5 displays the information about the merchandise sent to the display unit 505 from the server 100, then receives the user's selection with respect to the delivery request made via the operation unit 506. If a delivery is requested (a delivery request is made by the user), the user terminal 5 transmits the request to the server 100.

The delivery request sent to request reception unit 113 may reflect an input operation for selecting particular items to be included in the delivery from the all the items purchased during the predetermined period. In some examples, the request reception unit 113 may then transmit the information regarding the delivery request (including the information about the particularly selected merchandise) to the delivery person terminal 4. The information regarding the delivery is the information required for performing the delivery and is, for example, such things as a required container size or type and an address of the delivery destination in addition to the information about the items for the delivery.

The request reception unit 113 sends the information about the items purchased during the predetermined period to the user terminal 5 and also provides an estimated cost for the delivery fee as calculated using the information about the selected items and the information about the delivery destination.

In the present embodiment, the request transfer unit 114 transmits the information relating to the delivery request (received by the request reception unit 113) to the delivery person terminal 4.

The recommendation unit 112 transmits information to the user terminal 5 suggesting a delivery if, for example, the combined weight or volume of the items purchased during the predetermined period exceeds some threshold value. Here, the volume of each item can be calculated by multiplying the vertical dimension, the horizontal dimension, and the height stored in the merchandise information 122. In addition, the recommendation unit 112 may transmit a coupon to the user terminal 5 that can be used with the delivery request for a user who matches a coupon distribution condition. The distribution condition(s) for the coupon is included in the coupon information 124, and is, for example, related to the total value of the purchased items on the transaction day exceeding a predetermined threshold value.

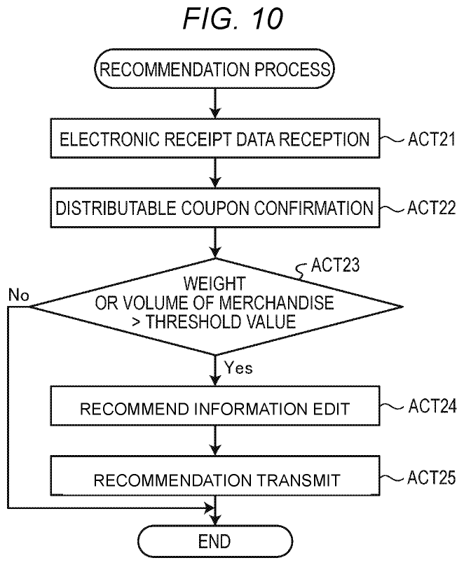

FIG. 10 is a flowchart of the recommendation process performed by the server 100 when functioning as the recommendation unit 112. When the electronic receipt data is received from the store 10 (ACT 21), the server 100 stores the received electronic receipt data in the storage unit 120. The server 100 next checks for a coupon that can be distributed to the user ID included in the electronic receipt data (ACT 22). In ACT 22, the server 100 may store a coupon ID in the storage unit 120 for which the distribution conditions (set in coupon information 124) match purchase circumstances (which are determined by reference to the electronic receipt data 125).

If the weight or the volume of the items presumed to be carried by the user exceeds a threshold value (Yes in ACT 23), the server 100 edits the recommendation information to be transmitted to the user terminal 5 (ACT 24). Here, the items considered to be carried by the user are items transacted (purchased) within the predetermined period. The recommendation information suggests a delivery request be made for the purchased items or otherwise information indicating the content of a newly distributed coupon. In ACT 25, the server 100 transmits the edited (in ACT 24) recommendation information to the user terminal 5. The user terminal 5 informs the user of the recommendation information, for example, by a notification function of an electronic receipt app or the like. A link to a screen for performing a delivery request is preferably added to the recommendation information displayed on the user terminal 5 as part of the notification function.

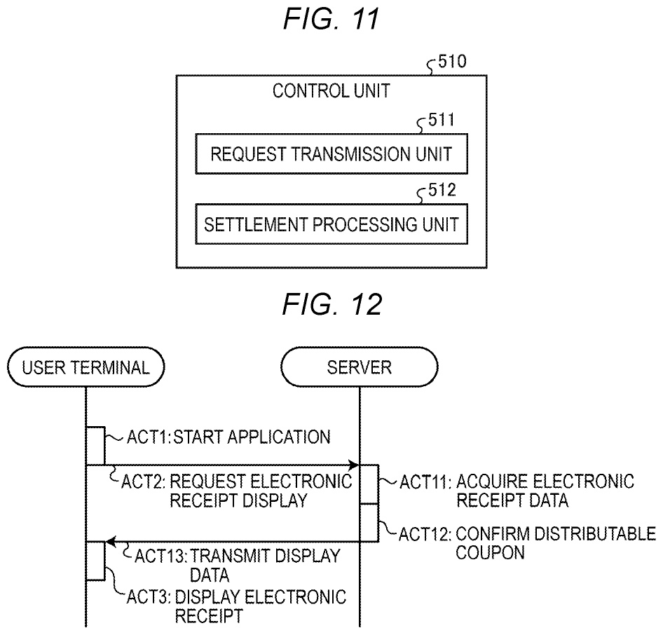

FIG. 11 is a diagram illustrating an example of the functional aspects of the control unit 510 of the user terminal 5. The control unit 510 functions as a request transmission unit 511 and a settlement process unit 512 by executing the program 521 by the CPU 501.

The request transmission unit 511 acquires the information about the items purchased during the predetermined period by the user from the server 100 and causes the display unit 505 to display the information together with an operating element (e.g., a button) for confirming request intention, and transmits the delivery request for the item (s) if the operating element is selected (e.g., pressed).

In addition, the request transmission unit 511 receives selection and deselection of the information about the items acquired from the server 100, displays the estimated delivery fee in response to the selected items, and performs a delivery request for the selected items if instructed by the user.

The settlement process unit 512 settles the charges relating to the delivery request with, for example, an online process using credit card information. The credit card information or the electronic money information used for the settlement is preferably registered in the user information 123 in advance, but credit card information or other electronic money information may be registered in the storage unit 520 of the user terminal 5 in advance and be selected via an electronic receipt app. Otherwise, the electronic receipt app may usably store the user information.

In this manner, online settlement using cashless settlement such as credit settlement is preferable, but the settlement by cash in which the user hands cash to the delivery person is also possible. In that case, the delivery person performs an operation of registering the completion of the settlement from the delivery person terminal 4.

Subsequently, the operations of each device are described. FIG. 12 is a sequence chart illustrating an example of a flow of the operations of the user terminal and the server from the electronic receipt app start to the electronic receipt display.

If the user terminal 5 receives an operation of the user by the operation unit 506, the CPU 501 executes the program 521 and starts the application program (the electronic receipt app and the user app) for referring to the electronic receipt data (ACT 1). The electronic receipt app at least stores a user ID as the setting.

The control unit 510 of the user terminal 5 transmits the electronic receipt display request to the server 100 in association with the start of the electronic receipt app (ACT 2). Here, the electronic receipt requested to be displayed is, for example, the electronic receipt of the latest transaction. At least the user ID is included in the electronic receipt display request.

After the electronic receipt display request is received, the server 100 acquires the electronic receipt data 125 matching the request from the storage unit 120 (ACT 11). The server 100 then confirms the presence or absence of a distributable coupon at this point of time associated with the user ID (ACT 12). The presence or absence of the distributable coupon can be confirmed by referring to the user information 123 stored, for example, in the storage unit 120 and confirming whether there is an owned coupon ID correlated to the user ID. Here, the server 100 transmits the data (display data) for displaying the electronic receipt data 125 on the display unit 505 to the user terminal 5 (ACT 13). At this point, if the presence of the owned coupon ID is confirmed in ACT 12, the corresponding coupon ID is also included in the display data and transmitted.

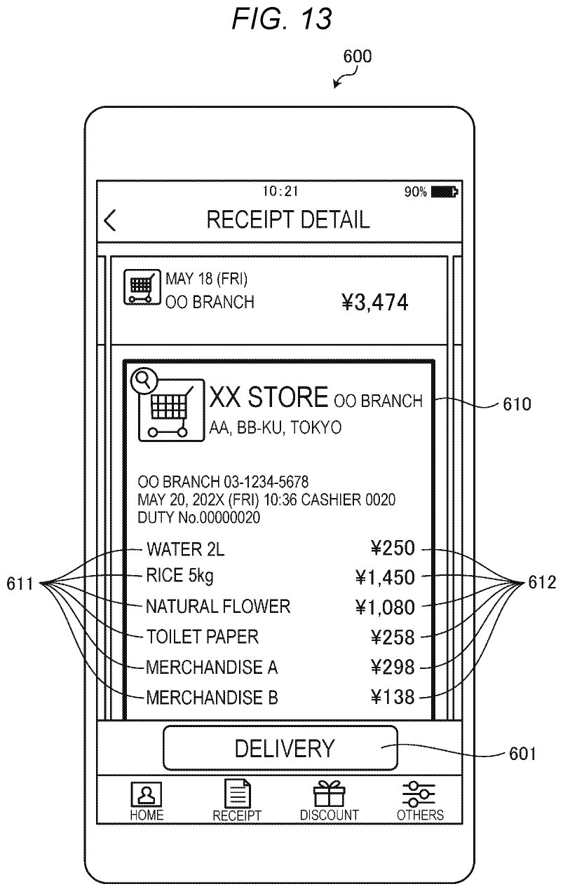

After the display data is received from the server 100, the user terminal 5 displays the electronic receipt based on the corresponding display data (ACT 3). FIG. 13 a diagram illustrating an example of an electronic receipt screen 600. The electronic receipt screen 600 is a screen for displaying an electronic receipt 610 and is displayed by the user terminal 5.

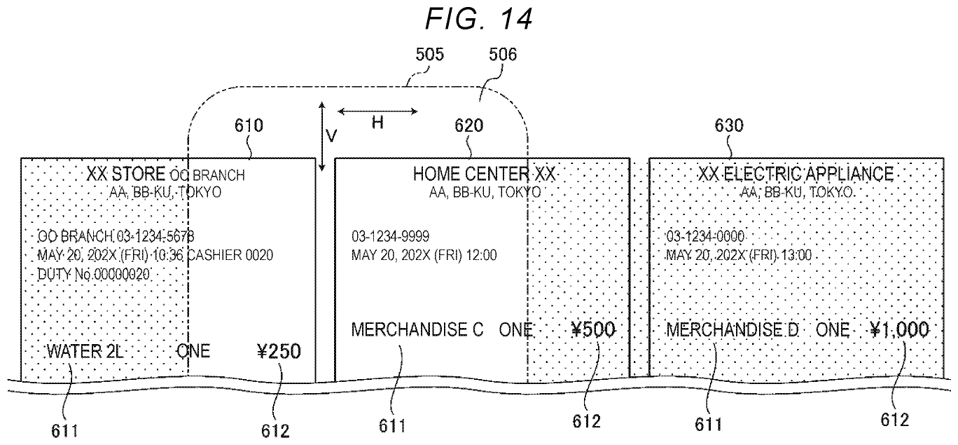

FIG. 14 is a diagram illustrating an example of a displaying method of the electronic receipt screen 600. As illustrated in FIG. 14, the electronic receipt screen 600 includes the plurality of electronic receipts 610, 620, and 630 that are the receipts of different transactions and changes the area displayed on the display unit 505 in association with the movement of a finger or the like of the user that touches the screen.

For example, if a position where the user touches the display unit 505 moves in the horizontal direction indicated by an arrow H, the electronic receipt displayed on the displaying area of the display unit 505 is changed. More specifically, if the user moves the finger that touches the display unit 505 from the right side to the left side during the display of the electronic receipt 610, the electronic receipt 610 is removed from the area displayed on the display unit 505, and an electronic receipt 620 is displayed on the display unit 505.

If the position where the user touches the display unit 505 moves in the vertical direction indicated by an arrow V, the electronic receipt 610 (620, or 630) displayed on the electronic receipt screen 600 moves in the vertical direction.

Referring back to FIG. 13, the electronic receipt 610 displays names 611 or prices 612 of the items purchased in the transaction indicated by the corresponding receipt. In addition, the electronic receipt screen 600 includes a delivery request button 601. If the delivery request button 601 is selected by the user, the control unit 510 determines that the user shows an intention to request a delivery and causes the display unit 505 to display a delivery reservation screen for requesting the delivery of the items displayed on the electronic receipt screen 600 from the corresponding electronic receipt 610.

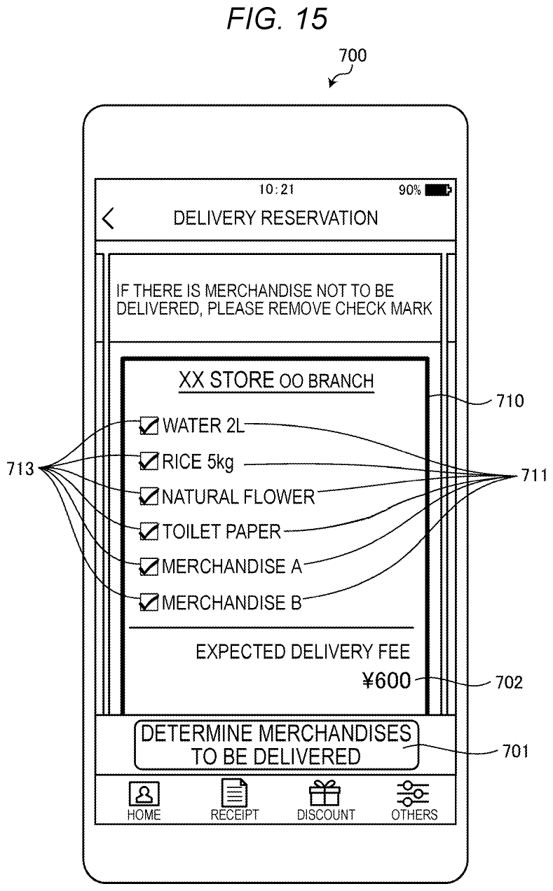

FIG. 15 is a diagram illustrating an example of a delivery reservation screen 700 in an initial state. Here, the initial state of the delivery reservation screen 700 is a state immediately after the screen transitions from the electronic receipt screen 600 by the delivery request button 601. The delivery reservation screen 700 displays a merchandise selection field 710 per transaction. The merchandise selection field 710 includes a name 711 (corresponding to the names 611) of the items purchased in the transaction indicated by the electronic receipt 610 and check boxes 713 that receive the user's selection of the item(s). The check boxes 713 switch between an on state (selected) and an off state (non-selected) whenever tapped by the user. The on state is a checked (selected) state, and the off state is an unchecked (unselected) state.

The delivery reservation screen 700 includes a delivery merchandise determination button 701 or an expected delivery fee display field 702. If the delivery merchandise determination button 701 receives an operation, the control unit 510 of the user terminal 5 determines that the user completes the selection of items to be delivered. The expected delivery fee display field 702 displays the estimated amount of the delivery fee calculated in response to the items for which the check boxes 713 are in on states, that is, the user selected items. Here, the expected delivery fee is determined based on the delivery destination and the characteristics of the selected items. That is, the expected delivery fee is calculated, for example, based on a distance from the current location of the user terminal 5 to the delivery destination (for example, the home address of the user) and the total volume (and/or weight) of the selected items.

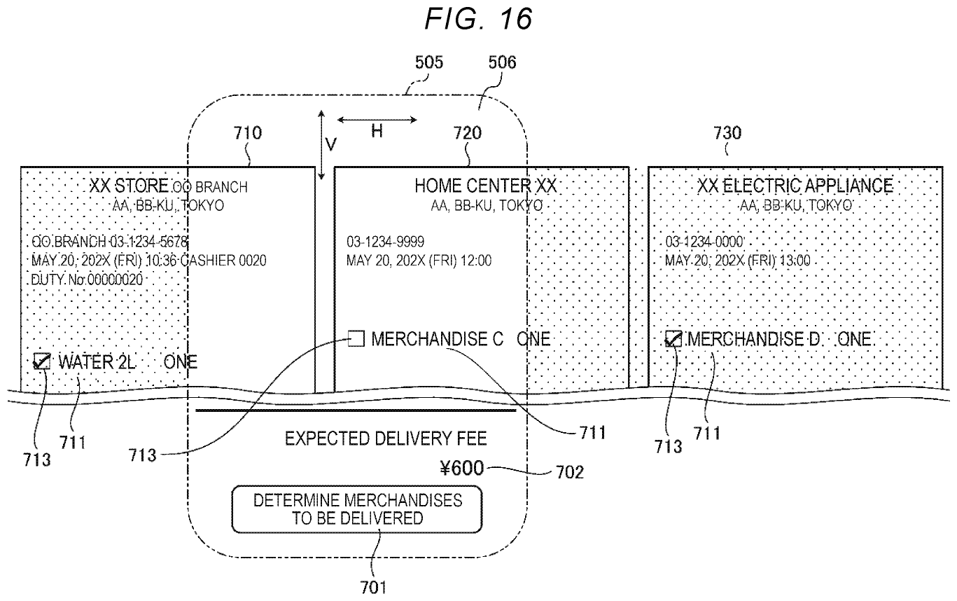

FIG. 16 is a diagram illustrating an example of the displaying method of the delivery reservation screen 700. In the same manner as the electronic receipt screen 600 illustrated in FIG. 14, the delivery reservation screen 700 includes the merchandise selection fields 710, 720, and 730 corresponding to the different electronic receipts 610, 620, and 630 and changes the area displayed on the display unit 505 in association with the movement of a finger or the like of the user that touches the screen.

For example, if the position where the user touches the display unit 505 moves in the horizontal direction indicated by the arrow H, the merchandise selection field displayed in the displaying area of the display unit 505 is changed. Specifically, if the user moves the finger that touches the display unit 505 from the right side to the left side during the display of the merchandise selection field 710, the merchandise selection field 710 is removed from the area displayed on the display unit 505, and a merchandise selection field 720 is displayed on the display unit 505.

If the position where the user touches the display unit 505 moves in the vertical direction indicated by the arrow V, the merchandise selection field 710 (720, or 730) displayed on the delivery reservation screen 700 moves in the vertical direction.

An electronic receipt corresponding to the transaction during a predetermined period is extracted on the delivery reservation screen 700 as a display target based on the timing if the delivery request button 601 receives an operation on the electronic receipt screen 600. The predetermined period as the extraction condition may be, for example, the same day (the day) as a default, and the length of the period may be changeably set to a predetermined number of days or hours. For example, in the example of FIG. 16, the control unit 510 extracts the electronic receipt relating to the transaction on the same day as the day if the delivery request button 601 receives the operation, as a display target. The delivery request button 601 may be displayed when the electronic receipt relating to a transaction within the predetermined period is displayed but is generally not to be displayed when an electronic receipt for a transaction outside of the predetermined period is displayed. For example, if the same day (present day) is set as the extraction condition, if the electronic receipt relating to the transaction of the present day is being displayed, the delivery request button 601 can be displayed in a selectable manner.

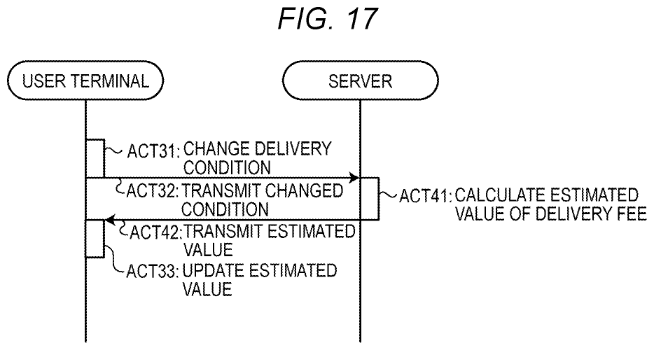

FIG. 17 is a sequence chart illustrating an example of a flow of operations of the user terminal and the server from the delivery condition change to the update of the delivery amount estimated value. The user terminal 5 displays the delivery reservation screen 700 by the electronic receipt app and performs an operation of changing the delivery condition in response to his or her own desire by the operation unit 506 (ACT 31).

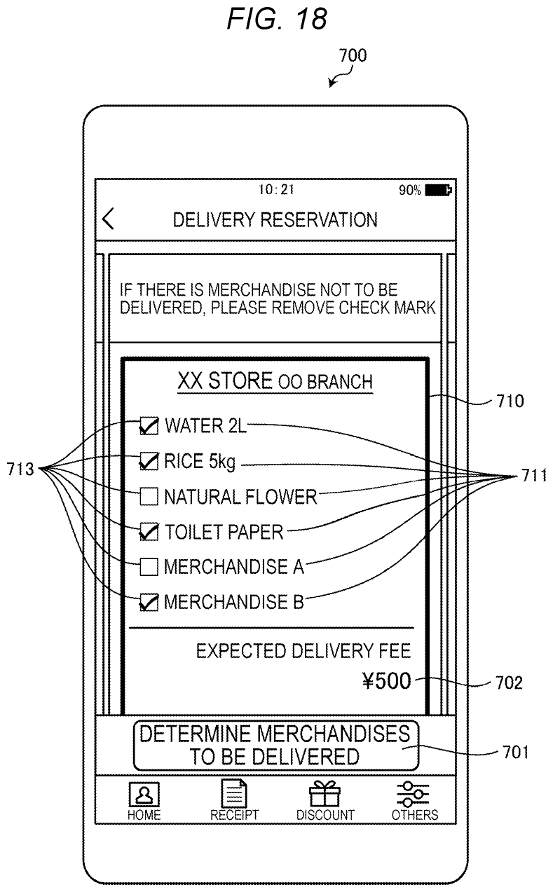

Here, FIG. 18 is a diagram illustrating an example of the delivery reservation screen 700 after the delivery condition change operation. The user changes the delivery condition by changing the check state of the check boxes 713. The user terminal 5 transmits the changed delivery conditions (the changed condition) received by the operation unit 506 to the server 100 (ACT 32). For example, in FIG. 18, a natural flower and a merchandise A that are selected in FIG. 15 are removed from the delivery items.

The server 100 that receives the changed condition from the user terminal 5 calculates the estimated value of the delivery fee suitable for the corresponding received delivery condition (ACT 41) and transmits the estimated value to the user terminal 5 (ACT 42).

The user terminal 5 that receives the estimated value from the server 100 updates the value displayed by the expected delivery fee display field 702 by the corresponding received estimated value (ACT 33). For example, as illustrated in FIG. 18, if the number of check boxes 713 in the on state is reduced, the expected delivery fee is reduced compared with a case where all of the check boxes 713 are in the on state as illustrated in FIG. 15.

However, in the delivery reservation screen 700, all of the check boxes 713 in the initial state (see FIG. 15) may be in the on state, or merchandise types that are deemed not suitable for delivery may be in an off state in advance. As items of merchandise not suitable for the delivery, such things as fresh flowers, live plants, animals, food that is purchased at a food court may be considered.

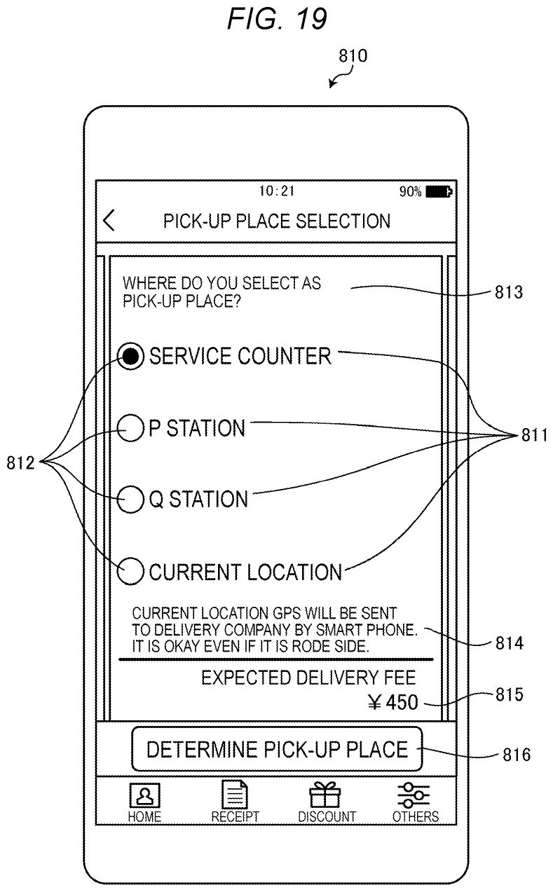

If the delivery merchandise determination button 701 of the delivery reservation screen 700 is selected, the control unit 510 of the user terminal 5 causes the display unit 505 to display the pick-up place selection screen. FIG. 19 is a diagram illustrating an example of the pick-up place selection screen 810. The pick-up place selection screen 810 includes candidate places 811, radio buttons 812, messages 813 and 814, an expected delivery fee display field 815, and a pick-up place determination button 816.

The candidate places 811 are options for places where the package (items) can be picked up and one or more thereof can be displayed. Examples of the candidate places 811 include a place closest to the current location of the user terminal 5 among those places where the package can be picked up. The radio buttons 812 associated with the candidate places 811 and receive user operation for selecting one of the candidate places 811. The messages 813 and 814 are a content of requesting selection of a pick-up place for the user and a content of describing the pickup at the current location.

A delivery fee is calculated for the candidate place 811 associated with the selected radio button 812 or home delivery is displayed in the expected delivery fee display field 815. The update of the value displayed in the expected delivery fee display field 815 is the same as the process relating to the update of the expected delivery fee display field 702 described in FIG. 17.

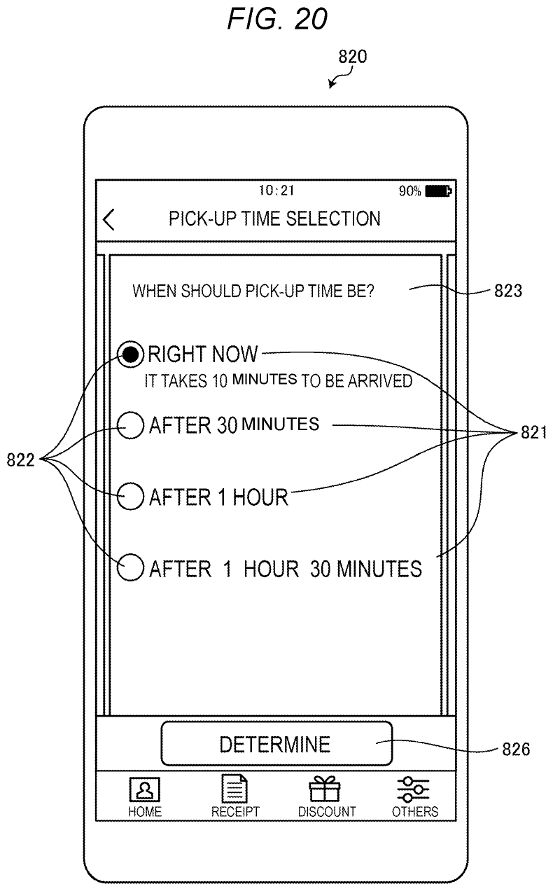

If the pick-up place determination button 816 is operated on the pick-up place selection screen 810, the control unit 510 of the user terminal 5 causes the display unit 505 to display the pick-up time selection screen. FIG. 20 is a diagram illustrating an example of a pick-up time selection screen 820.

The pick-up time selection screen 820 includes options 821, radio buttons 822, a message 823, and a determination button 826. The determination button 826 is an example of an operating element for confirming the request intention.

The options 821 are options of the time when the package (items) is to be picked up, and one or more thereof are displayed. Examples of the options 821 include “Right now/It takes 10 minutes to be arrived”, “after 30 minutes”, “after one hour”, or any other value.

The radio buttons 822 are disposed in association with the options 821 and receive an operation of selecting any one of the options 821. The message 823 is the content (e.g., text) requesting selection of the pick-up time for the user.

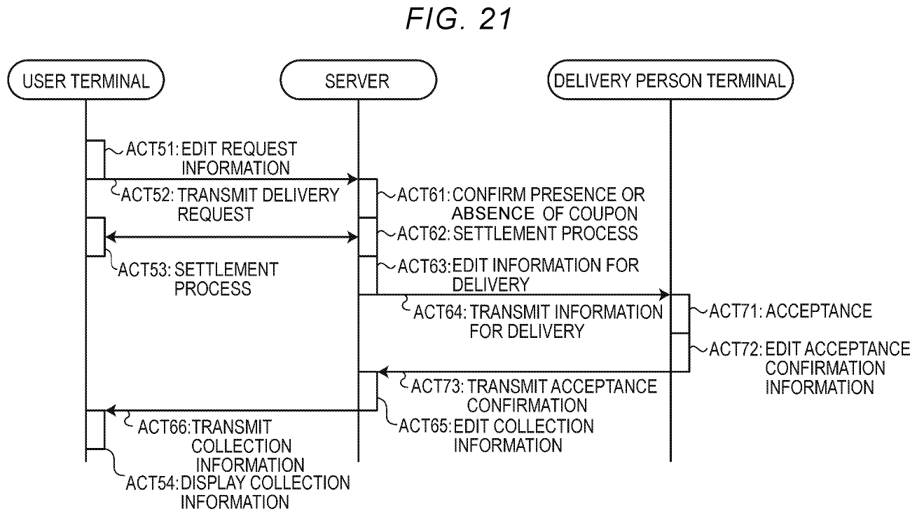

If the determination button 826 is operated on the pick-up time selection screen 820, the control unit 510 of the user terminal 5 transitions to the process illustrated in FIG. 21. In addition, prior to the process illustrated in FIG. 21, the user terminal 5 may receive the designation of a delivery destination other than a home address, the application or non-application of a coupon, and the like by user input operations or pre-selections.

FIG. 21 is a sequence chart illustrating an example of a flow of operations of the user terminal and the server from the delivery request information editing to the collection information display. If the determination button 826 is operated on the pick-up time selection screen 820, the control unit 510 of the user terminal 5 edits the request information (ACT 51). Examples of the request information include the user ID of a requester (user), information about the coupon used for the delivery at this time (coupon ID), the information about the delivered merchandise (for example, a merchandise code or the number of items), the pick-up place, and the pick-up time.

The user terminal 5 that completes the editing of the request information transmits the delivery request to which the corresponding request information is added to the server (ACT 52).

The server 100 that receives the delivery request confirms whether the information about the coupon is included in the delivery request (ACT 61), and performs the settlement process (ACT 62). This settlement process is performed in cooperation with the user terminal 5. That is, at this point, the settlement process is also performed in the user terminal 5 (ACT 53). The settlement process herein is preferably a cashless settlement type such as credit card settlement.

After the settlement process is completed, the server 100 edits the information for delivery (ACT 63). The information for delivery is the information required by the delivery person to make the delivery, and includes, for example, the name of the requester (user), information about the items to be delivered (merchandise names, the number of items of each type, the weights, the sizes), the pick-up place, the pick-up time, and the delivery destination. The server 100 that completes the editing of the information for delivery transmits the information for delivery to the delivery person terminal 4.

If the delivery person uses the delivery person terminal 4 to perform accept the request via the operation unit 406 with the delivery person app (ACT 71), the delivery person terminal 4 edits (as necessary) acceptance confirmation information (ACT 72) and transmits the acceptance information to the server 100 (ACT 73).

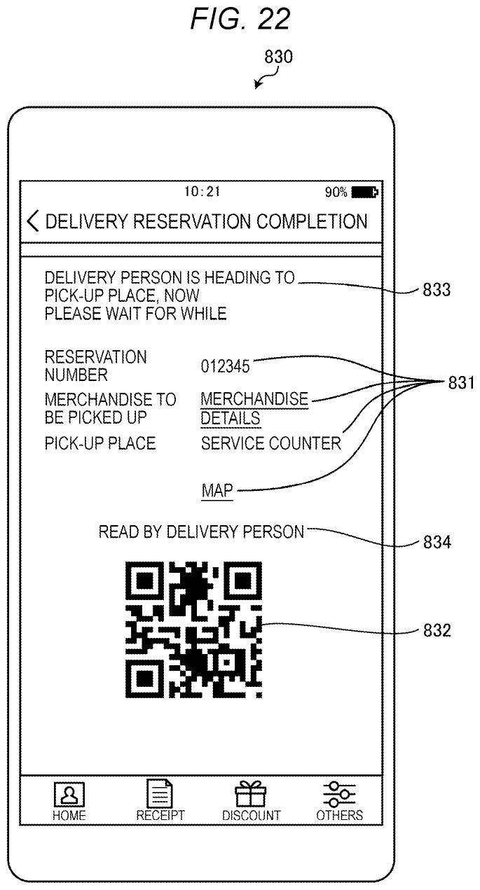

The server 100 then edits the collection information (ACT 65) and transmits the edited collection information to the user terminal 5 (ACT 66). The control unit 510 of the user terminal 5 displays the relevant collection information on the display unit 505 (ACT 54). The collection information notifies the user (requester) of the collection details (location, time, etc.) and is displayed, for example, on the delivery reservation completion screen. FIG. 22 is a diagram illustrating an example of a delivery reservation completion screen 830.

The delivery reservation completion screen 830 includes messages 833 and 834 in addition to collection information 831 and a code symbol 832, for example.

Examples of the collection information 831 include a reservation number for the corresponding delivery reservation, information about the items to be picked up, the name of the pick-up place, and a link (URL information) to a map of the place. The information about the items to be picked up is a link for displaying detailed information about the items to be delivered.

The code symbol 832 includes at least the information such as the reservation number for specifying the corresponding delivery reservation. The delivery person terminal 4 reads the code symbol 832 with a code reader using a camera in the delivery person terminal 4 to identify the information about the delivery reservation indicated by the user terminal 5. If the delivery reservation matches the accepted delivery request, the information indicating that the delivery person has started the delivery is transmitted to the server 100.

A message 833 is text, for example, for indicating that the delivery person is heading for the pick-up place. A message 834 is text, for example, indicating that the code symbol 832 is to be read by the delivery person using the delivery person terminal 4.

With the electronic receipt system as described above, by using the electronic receipt data 125, a delivery request of the package(s) accumulated during shopping can be more easily performed. Not only can the delivery of items purchased in a single transaction at one store be requested as in the related art, but also items purchased from a plurality of different stores during the same shopping trip can be requested to be delivered in accordance with a single delivery request. Thus, it is more convenient for shoppers to make multi-store shopping trips and continue shopping after several purchases have already been made. Therefore, the user can request delivery without significant planning burden, so the system is likely to contribute to more usage of the delivery request option and receptiveness to promotions of the delivery request service. In some instances, a discount coupon or a voucher that can be used when paying for use of the delivery service can be provided to the user, and thus the adoption/usage of the delivery service can be further promoted.

In addition, if the electronic receipt data 125 is used for the providing relevant information regarding the items associated with delivery request, then the size and/or weight of the package(s) to be delivered can be precisely predicted. Accordingly, the delivery person can prepare an appropriate container (or packaging/wrapping material) for the package(s) and before leaving for the designated pick-up place. In some instances, the user may be able to request the delivery of the items without additional wrapping/packaging material in some instances.

In addition, the user can perform a delivery request without an effort of manually filling in a shipping tag or shipping request. The settlement for the delivery can also be made conveniently without cash at the time the delivery request is made.

In addition, the address included in the user information 123 can be set as the initial value of the delivery destination, and the delivery destination can be changed as required, but more specifically, another option for the delivery destination may be set in advance. In such a case, the selected option for the delivery destination can be stored in the server 100 as a content sent from the user terminal 5. In such a configuration, the user effort required for completing the delivery request can be further reduced.

In addition, for example, a taxi driver can work as a delivery person during free times by possessing a delivery person terminal 4 or the like.

In addition, the above example embodiments can be appropriately modified and various aspects changed or adjusted by changing a part of the above described configurations or functions of each device.

The programs executed by each device (server 100, user terminal 5, and delivery person terminal 4) can be incorporated in a ROM or the like in advance. The programs executed by each device may be recorded as a file in an installable format or an executable format on a computer-readable recording medium such as CD-ROM, CD-R, or Digital Versatile Disk (DVD).

Furthermore, the programs executed by each device of the above embodiment may be configured to be stored on a computer connected to a network such as the Internet and provided by being downloaded via the network. Further, the program executed by each device may be configured to be provided or distributed via a network such as the Internet.

While certain embodiments have been described, these embodiments have been presented by way of example only, and are not intended to limit the scope of the inventions. Indeed, the novel embodiment described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing server device for an electronic receipt system, the server device comprising:
a communication interface configured to receive electronic receipt data from a plurality of stores;
a storage unit for storing electronic receipt data received from the plurality of stores in association with a user ID; and
a processor configured to:
acquire information from the stored electronic receipt data about items of merchandise purchased within a predetermined period by a user associated with the user ID;
cause a user terminal associated with the user ID to display the information about the items of merchandise purchased during the predetermined period along with a delivery request button;
receive, via the communication interface, a delivery request from the user terminal for one or more items of merchandise; and
transmit, via the communication interface, information relating to the delivery request to a delivery person terminal.

2. The server device according to claim 1, wherein the processor is further configured to:
check for coupon information associated with the user ID in the storage unit; and
transmit the coupon information to the user terminal if a coupon distribution condition associated with the coupon information is met.

3. The server device according to claim 1, wherein the communication interface is further configured to receive coupon information from a delivery company and store the coupon information in the storage unit.

4. The server device according to claim 1, wherein the processor is further configured to transmit electronic receipt information to the user terminal.

5. The server device according to claim 1, wherein the communication interface is configured to connect to the delivery person terminal via a network connection.

6. The server device according to claim 1, wherein the processor is further configured to:
transmit, via the communication interface, a delivery recommendation notification to the user terminal when a total weight or volume of items of merchandise purchased at different stores during the predetermined period, as indicated by the electronic receipt data, exceeds a threshold value.

7. The server device according to claim 1, wherein the processor is further configured to:
process a payment associated with the delivery request based on payment information stored in association with the user ID in the storage unit.

8. A terminal device for an electronic receipt system, the terminal device comprising:
a communication interface configured to receive data from an information processing server of an electronic receipt system;
a display screen; and
a processor configured to:
cause the display screen to display information about items of merchandise received, via the communication interface, from the information processing server, the information about the items of merchandise being displayed along with a delivery request button, and
transmit, via the communication interface, a delivery request to the information processing server if the delivery request button is pressed.

9. The terminal device according to claim 8, wherein the processor is further configured to:
cause the display screen to display an estimated delivery charge provided by the information processing device in response to the transmitted delivery request.

10. The terminal device according to claim 9, wherein identifying names of individual items of merchandise are displayed on the display screen in a selectable format permitting the user to select or deselect individual items to be associated with the delivery request.

11. The terminal device according to claim 8, wherein identifying names of individual items of merchandise are displayed on the display screen in a selectable format permitting the user to select or deselect individual items to be associated with the delivery request.

12. The terminal device according to claim 8, wherein the processor is further configured to:
cause the display screen to display a collection location address.

13. The terminal device according to claim 8, further comprising:
a storage unit storing an electronic receipt application program.

14. A non-transitory, computer-readable medium storing program instructions which when executed by a processor of an information processing server device of an electronic receipt system cause the processor to perform a method comprising:
acquire, from electronic receipt data stored in a storage unit, information about items of merchandise purchased within a predetermined period by a user associated with a user ID;
cause a user terminal associated with the user ID to display the information about the items of merchandise purchased during the predetermined period along with a delivery request button;
receive, via a communication interface, a delivery request from the user terminal for one or more items of merchandise; and
transmit, via the communication interface, information relating to the delivery request to a delivery person terminal.

15. The non-transitory, computer-readable medium according to claim 14, the method further comprising:
check for coupon information associated with the user ID in the storage unit; and
transmit the coupon information to the user terminal if a coupon distribution condition associated with the coupon information is met.

16. The non-transitory, computer-readable medium according to claim 14, the method further comprising:
receive coupon information, via the communication interface, from a delivery company; and
store the coupon information in the storage unit.

17. The non-transitory, computer-readable medium according to claim 14, the method further comprising:
transmit electronic receipt information to the user terminal.

18. The non-transitory, computer-readable medium according to claim 14, the method further comprising:
transmit, via the communication interface, a delivery recommendation notification to the user terminal when a total weight or volume of items of merchandise purchased at different stores during the predetermined period, as indicated by the electronic receipt data, exceeds a threshold value.

19. The non-transitory, computer-readable medium according to claim 14, the method further comprising:
process a payment associated with the delivery request based on payment information stored in association with the user ID in the storage unit.
